(19) United States
(12) Patent Application Publication
(10) Pub. No.: US 2026/0008288 A1
(43) Pub. Date: Jan. 8, 2026

(54) EMBOSSED INKJET MEDIA FILM FOR LARGE-FORMAT PRINTING

(71) Applicants: Kwang Seok SONG, Gimhae-si (KR); Kwang Rae CHO, Busan (KR); HICO CO., LTD., Gimhae-si (KR)

(72) Inventors: Kwang Seok SONG, Gimhae-si (KR); Kwang Rae CHO, Busan (KR)

(21) Appl. No.: 19/088,417

(22) Filed: Mar. 24, 2025

(30) Foreign Application Priority Data
Jul. 2, 2024 (KR) 10-2024-0086734

(51) Int. Cl. B41M 5/50; C09D 11/54

(52) U.S. Cl. CPC B41M 5/508; B41M 5/506; B41M 5/5254

(57) ABSTRACT

Proposed is an embossed film printable through large-format printing, which is, more particularly, an embossed film printable through large-format printing using a digital printer after forming an embossed pattern and attachable to a variety of surfaces. To this end, the embossed film includes a single material layer, a primer layer being formed by coating an upper portion of the single material layer with a primer solution and then subjecting the resulting product to hot-air drying, and a top layer with which an upper portion of the primer layer is coated, wherein the top layer further includes an ink-absorbing layer being formed by coating the upper portion of the primer layer with a top coating solution and then subjecting the resulting product to hot-air drying and irradiation using an ultraviolet (UV) lamp and an embossed pattern layer being formed by imprinting an embossed pattern using heat and an embossing roll.

### REFERENCE TO RELATED APPLICATIONS

This application claims the priority benefit of Korean Patent Application No. 10-2024-0086734 filed on Jul. 2, 2024 the entire contents of which are incorporated herein by reference.

### FIELD OF THE INVENTION

The present disclosure relates to an embossed inkjet media film for large-format printing. More particularly, the present disclosure relates to an embossed film being printable through large-format printing using a digital printer after forming an embossed pattern, being attachable to a variety of surfaces, and serving as media to inform consumers of various pieces of information by attaching such a film printed through large-format printing to a variety of surfaces.

### BACKGROUND OF THE INVENTION

Typically, in the manufacture of all types of home appliances, such as refrigerators, televisions, washing machines, and microwave ovens, or interior and exterior materials applied to decorate the interior and exterior of buildings, plates made of various materials, such as metal plates, non-ferrous metal plates, synthetic resin plates, and medium-density fiberboards (MDFs), are being applied in accordance to the characteristics of products.

However, when boards applied to the aforementioned interior and exterior materials of buildings or all types of home appliances are left unattended, the surfaces of such boards are corroded by air, moisture, and the like in the atmosphere, leading to significant deterioration in durability. In addition, the surfaces are likely to get scratched due to carelessness during handling, including transportation, and products are challenging to upgrade due to the unattractive exterior, which is problematic.

Thus, methods involving painting or attaching sheet paper with various colors or patterns to the surface of a board have been proposed to address existing problems as described above.

However, even in these cases, such paint applied onto or sheet paper attached to the surface of a board is peeled off or damaged over time, respectively, which is problematic.

Furthermore, such existing sheet paper is typically used only for sinks and interior wallpapers and, in particular, printed on color films or formed into various patterns for commercialization.

In other words, the usage is limited, the use of color films limits available colors, and especially when printing is required, the inconvenience of having to take this into consideration arises.

In addition, the manufacturers finalize products for commercialization by forming patterns on color films or printed films, making it challenging for consumers to obtain desired patterns or printouts, which is problematic.

### DOCUMENTS OF RELATED ART

### Patent Documents

(Patent Document 001) Korean Patent Application Publication No. 10-2010-0109051 (Oct. 8, 2010)

(Patent Document 002) Korean Patent No. 10-1213258 (Dec. 11, 2012).

### SUMMARY OF THE INVENTION

The present disclosure, which has been devised to address the problems described above, aims to provide an embossed inkjet media film for large-format printing, which enables consumers to obtain desired patterns or printouts.

In addition, the present disclosure aims to provide an embossed inkjet media film for large-format printing, which is easily attachable to any desired surface for various consumers.

Furthermore, the present disclosure aims to provide an embossed inkjet media film for large-format printing, which serves as media to inform consumers of various pieces of information by attaching such a film printed through large-format printing.

It is further stated that other objectives and advantages of the present disclosure will be described below and will be encompassed in a broader scope not only by the details described in the scope of the appended claims of the present disclosure and the description of the embodiments thereof but also by means and combinations within the scope that is easily derivable therefrom.

The present disclosure for achieving the objectives described above is characterized in that an embossed inkjet media film for large-format printing includes: a single material layer having a thickness in the range of 60 to 300 μm; a primer layer being formed by coating an upper portion of the single material layer with a primer solution, the primer layer being formed by coating the upper portion of the single material layer with the primer solution to a thickness in the range of 1 to 5 μm and then subjecting the resulting product to hot-air drying at a temperature in the range of 50° C. to 140° C.; and a top layer with which an upper portion of the primer layer is coated, the top layer being embossable and printable, wherein the top layer further includes: an ink-absorbing layer being formed by coating the upper portion of the primer layer with a top coating solution to a thickness in the range of 10 to 150 μm and then subjecting the resulting product to hot-air drying at a temperature in the range of 50° C. to 140° C. and irradiation using an ultraviolet (UV) lamp at a UV dose in the range of 100 to 500 mJ/cm2; and an embossed pattern layer being formed by imprinting an embossed pattern using heat and an embossing roll.

In addition, according to one preferred embodiment of the present disclosure, the single material layer is characterized by being made of any one of polyvinyl chloride (PVC), polypropylene (PP), polyethylene terephthalate (PET), or paper.

In the meantime, the present disclosure for achieving the objectives described above is characterized in that a method of manufacturing the aforementioned embossed film printable through large-format printing includes the following steps: preparing a single material layer having a thickness in the range of 60 to 300 μm; coating an upper portion of the single material layer with a primer solution to a thickness in the range of 1 to 5 μm and then subjecting the resulting product to hot-air drying at a temperature in the range of 50° C. to 140° C. to form a primer layer; coating an upper portion of the primer layer with a top coating solution to a thickness in the range of 10 to 150 μm and then subjecting the resulting product to hot-air drying at a temperature in the range of 50° C. to 140° C. and irradiation using a UV lamp at a UV dose in the range of 100 to 500 mJ/cm2 to form an ink-absorbing layer; and forming an embossed pattern layer using heat and an embossing roll.

In the meantime, the present disclosure for achieving the objectives described above is characterized in that an embossed inkjet media film for large-format printing includes: an upper PP layer being attached to an upper portion of a bonding layer and having a thickness in the range of 60 to 300 μm; a lower PP layer or a PET layer being attached to a lower portion of the bonding layer and having a thickness in the range of 60 to 300 μm; a primer layer being formed by coating an upper portion of the upper PP layer with a primer solution, the primer layer being formed by coating the upper portion of the upper PP layer with the primer solution to a thickness in the range of 1 to 5 μm and then subjecting the resulting product to hot-air drying at a temperature in the range of 50° C. to 140° C.; and a top layer with which an upper portion of the primer layer is coated, the top layer being embossable and printable, wherein the top layer further includes: an ink-absorbing layer being formed by coating the upper portion of the primer layer with a top coating solution to a thickness in the range of 10 to 150 μm and then subjecting the resulting product to hot-air drying at a temperature in the range of 50° C. to 140° C. or irradiation using a UV lamp at a UV dose in the range of 100 to 500 mJ/cm2; and an embossed pattern layer being formed by imprinting an embossed pattern using heat and an embossing roll.

In addition, according to one preferred embodiment of the present disclosure, the embossed pattern layer is characterized by being formed by imprinting the embossed pattern using the embossing roll at a pressure in the range of 1 to 3 kg/cm2 under the following conditions: a temperature of a main drum in the range of 140° C. to 170° C. and a temperature of the embossing roll in the range of 30° C. to 60° C.

In the meantime, the present disclosure for achieving the objectives described above is characterized in that a method of manufacturing the aforementioned embossed film printable through large-format printing includes the following steps: bonding an upper PP layer having a thickness in the range of 60 to 300 μm to an upper portion of a bonding layer and bonding a lower PP layer or a PET layer having a thickness in the range of 60 to 300 μm to a lower portion of the bonding layer; coating an upper portion of the upper PP layer with a primer solution to a thickness in the range of 1 to 5 μm and then subjecting the resulting product to hot-air drying at a temperature in the range of 50° C. to 140° C. to form a primer layer; coating an upper portion of the primer layer with a top coating solution to a thickness in the range of 10 to 150 μm and then subjecting the resulting product to hot-air drying at a temperature in the range of 50° C. to 140° C. or irradiation using a UV lamp at a UV dose in the range of 100 to 500 mJ/cm2 to form an ink-absorbing layer; and forming an embossed pattern layer using heat and an embossing roll.

As described above, the following effects can be expected according to the present disclosure.

An embossed inkjet media film can be printed through large-format printing.

In other words, the embossed inkjet media film can be printed through large-format printing by a printing method using a digital printer rather than existing printing methods using gravure machines.

In addition, consumers can obtain desired patterns or printouts.

In other words, unlike the existing manufacturers finalize products for commercialization by performing printing on color films using gravure machines and forming patterns on such color films or printed films, a finalized product subjected to an embossing process is released in the present disclosure and thus can allow consumers to use the resulting product obtained through desired large-format printing.

Furthermore, unlike existing films used only for sinks, interior wallpapers, and the like, various consumers can easily attach this film to any desired surface without limiting the usage thereof.

Moreover, such a film printed through large-format printing can be attached to a variety of surfaces and thus serve as media by informing consumers of various pieces of information.

It is further stated that other effects of the present disclosure will be encompassed in a broader scope by effects of not only the details described in the embodiments described above and the appended claims of the present disclosure but also those that can occur within the scope that is easily derivable therefrom, and by possibilities of potential advantages contributing to industrial development.

### BRIEF DESCRIPTION OF THE DRAWINGS

FIG. 1 is a diagram illustrating an embossed inkjet media film for large-format printing, according to a first embodiment of the present disclosure;

FIG. 2 is a flowchart illustrating a method of manufacturing an embossed inkjet media film for large-format printing, according to the first embodiment of the present disclosure;

FIG. 3 is a diagram illustrating an embossed inkjet media film for large-format printing, according to a second embodiment of the present disclosure;

FIG. 4 is a flowchart illustrating a method of manufacturing an embossed inkjet media film for large-format printing, according to the second embodiment of the present disclosure;

FIG. 5 is a diagram illustrating an embossed inkjet media film for large-format printing, according to a third embodiment of the present disclosure;

FIG. 6 is a flowchart illustrating a method of manufacturing an embossed inkjet media film for large-format printing, according to the third embodiment of the present disclosure; and

FIG. 7 is a diagram illustrating an embossed inkjet media film for large-format printing, according to a fourth embodiment of the present disclosure.

### DETAILED DESCRIPTION OF THE INVENTION

Hereinafter, preferred embodiments of the present disclosure will be described in detail with reference to the attached drawings. Before describing the details, it should be noted that the advantages and characteristics of the present disclosure and methods for achieving those will become clear with reference to the following embodiments described in detail in conjunction with the attached drawings. In addition, the terms used herein are disclosed for illustrative purposes of the embodiments and are not intended to limit the present disclosure. Among such terms, the singular forms include the plural forms as well unless the context clearly indicates otherwise. Furthermore, in the following description, a word indicating a direction is provided to help understand the description and should be understood as being modifiable on the basis of a viewpoint.

Hereinafter, an embossed film printable through large-format printing, according to preferred embodiments of the present disclosure, will be described in detail with reference to the attached drawings.

### First Embodiment

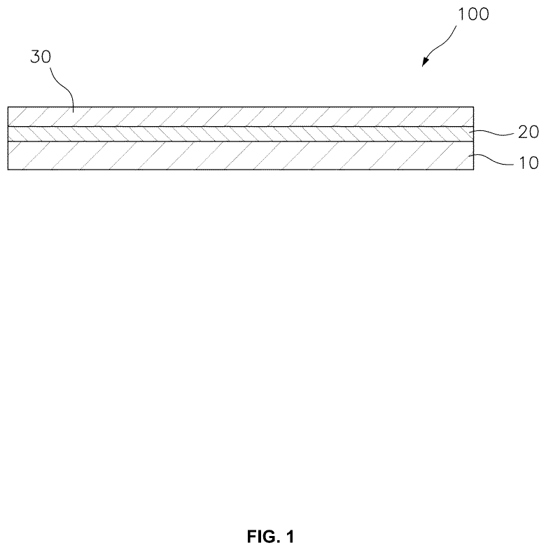

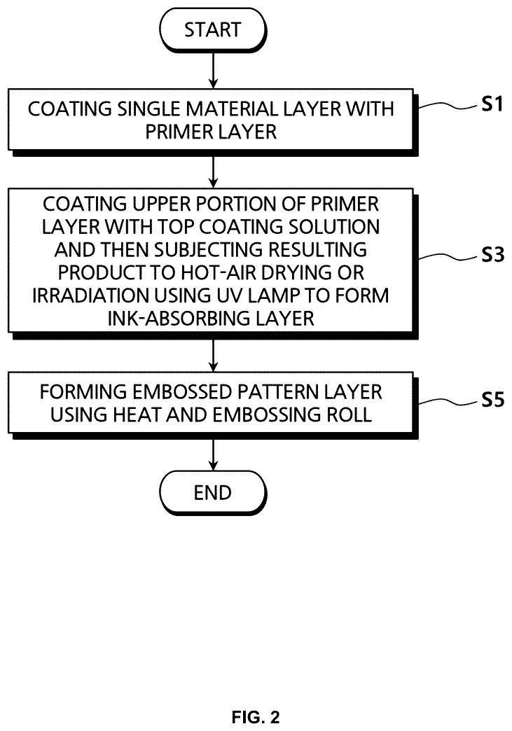

FIG. 1 is a diagram illustrating an embossed inkjet media film for large-format printing, according to a first embodiment of the present disclosure, and FIG. 2 is a flowchart illustrating a method of manufacturing the embossed inkjet media film for large-format printing, according to the first embodiment of the present disclosure.

First, referring to FIG. 1, the embossed inkjet media film 100 for large-format printing, according to the present disclosure, includes a single material layer 10, a primer layer 20, and a top layer 30.

The single material layer 10 has a thickness in the range of 60 to 300 μm and may be made of any one of polyvinyl chloride (PVC), polypropylene (PP), polyethylene terephthalate (PET), or paper.

The upper portion of the single material layer 10 is coated with the primer layer 20.

The primer layer 20, configured to increase the adhesion between the single material layer 10 and the top layer 30, is formed by coating the upper portion of the single material layer 10 with a primer solution.

In other words, the primer layer 20 is formed by coating the upper portion of the single material layer 10 with the primer solution to a thickness in the range of 1 to 5 μm and then subjecting the resulting product to hot-air drying at a temperature in the range of 50° C. to 140° C.

The upper portion of the primer layer 20 is coated with the top layer 30, which is embossable and printable.

Such a top layer 30 includes: an ink-absorbing layer to be formed by applying a top coating solution and drying the resulting product; and an embossed pattern layer to imprint an embossed pattern on the ink-absorbing layer.

First, to form the top layer 30, the top coating solution is applied to a thickness in the range of 10 to 150 μm. In this case, the top coating solution is applied by controlling the thickness using a roll provided on and under the material having a form in which the primer layer 20 is formed on the single material layer 10.

Then, the resulting product is subjected to hot-air drying at a temperature in the range of 50° C. to 140° C. and irradiation using a UV lamp at a UV dose in the range of 100 to 500 mJ/cm2 to form the ink-absorbing layer. Such an ink-absorbing layer literally refers to a condition where ink for printing can be absorbed.

The ink-absorbing layer is formed by coating the upper portion of the primer layer with the top coating solution through any one of various methods involving comma coating, slot-die coating, a lip coater, a micro gravure coater, a gravure coater, and the like.

With such an ink-absorbing layer formed, the embossed pattern layer may be formed in the top layer 30 by imprinting the embossed pattern using heat and an embossing roll.

The embossed pattern layer is subjected to a preheating process, a main drum process, and an embossing roll process, and the process conditions vary depending on the material of the single material layer 10.

In other words, when the single material layer 10 is made of PVC, the embossed pattern layer is formed by imprinting the embossed pattern using the embossing roll at a pressure in the range of 1 to 2 kg/cm2 under the following conditions: a temperature of the main drum in the range of 50° C. to 90° C. and a temperature of the embossing roll in the range of 30° C. to 50° C.

In addition, when the single material layer 10 is made of PP, the embossed pattern layer is formed by imprinting the embossed pattern using the embossing roll at a pressure in the range of 1 to 2 kg/cm2 under the following conditions: a temperature of the main drum in the range of 100° C. to 140° C. and a temperature of the embossing roll in the range of 30° C. to 60° C.

Furthermore, when the single material layer 10 is made of PET, the embossed pattern layer is formed by imprinting the embossed pattern using the embossing roll at a pressure in the range of 1 to 3 kg/cm2 under the following conditions: a temperature of the main drum in the range of 140° C. to 170° C. and a temperature of the embossing roll in the range of 30° C. to 60° C.

In addition, when the single material layer 10 is made of paper, the embossed pattern layer is formed by imprinting the embossed pattern using the embossing roll at a pressure in the range of 1 to 4 kg/cm2 under the following conditions: a temperature of the main drum in the range of 100° C. to 140° C. and a temperature of the embossing roll in the range of 30° C. to 60° C.

As described above, the process conditions that vary depending on the material of the single material layer 10 are based on the characteristics of each material. PVC and PP are soft and highly susceptible to heat, while PET and paper are hard and have high heat resistance. Accordingly, the drying process is carried out by varying the temperature of hot air, the temperature of the embossing roll, and the pressure depending on each material.

In the meantime, the top layer 30 may be made of organic beads, inorganic beads, or metal beads, either alone or in a mixed form. The organic beads or particles may be polymethyl methacrylate, polystyrene, or polypropylene, the inorganic beads or particles may be silicon, silicon carbide, silica, glass, glass bubbles, alumina ceramic, or silicate ceramic, and the metal beads or particles may be alumina, zirconia, or chromium oxide.

Hereinafter, a method of manufacturing the embossed inkjet media film 100 for large-format printing, according to this embodiment, will be described. FIG. 2 is a flowchart illustrating the method of manufacturing the embossed inkjet media film for large-format printing, according to the first embodiment of the present disclosure.

Referring to the drawings, as illustrated in FIG. 2, the single material layer 10 is coated with the primer layer 20 (S1).

As mentioned above, the single material layer 10 has a thickness in the range of 60 to 300 μm and may be made of any one of PVC, PP, PET, or paper. In addition, the primer layer 20 is formed by coating the upper portion of the single material layer 10 with the primer solution to increase the adhesion between the single material layer 10 and the top layer 30.

Such a primer layer 20 is formed by coating the upper portion of the single material layer with the primer solution to a thickness in the range of 1 to 5 μm and then subjecting the resulting product to hot-air drying at a temperature in the range of 50° C. to 140° C.

Then, the top layer 30 is formed on the primer layer 20. For such a top layer 30, the upper portion of the primer layer 20 is coated with the top coating solution, and the resulting product is then subjected to hot-air drying or irradiation using the UV lamp to form the ink-absorbing layer (S3).

In this case, after coating the upper portion of the primer layer 20 with the top coating solution to a thickness in the range of 10 to 150 μm, the resulting product is subjected to hot-air drying at a temperature in the range of 50° C. to 140° C. or irradiation using the UV lamp at a UV dose in the range of 100 to 500 mJ/cm2 to form the ink-absorbing layer.

Next, the embossed pattern layer is formed using heat and the embossing roll (S5).

As mentioned above, the formation of the embossed pattern layer is carried out under varying process conditions depending on the material of the single material layer 10 and may be omitted depending on the needs of consumers.

### Second Embodiment

Hereinafter, another example of an embossed inkjet media film for large-format printing, according to one preferred embodiment of the present disclosure, will be described in detail with reference to the attached drawings.

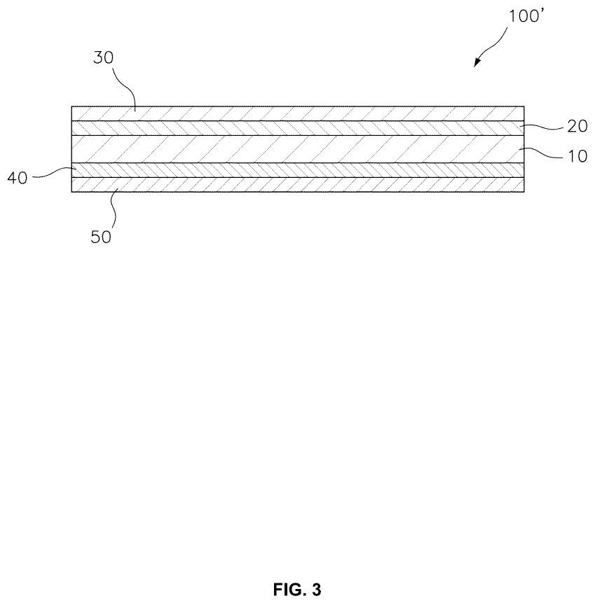

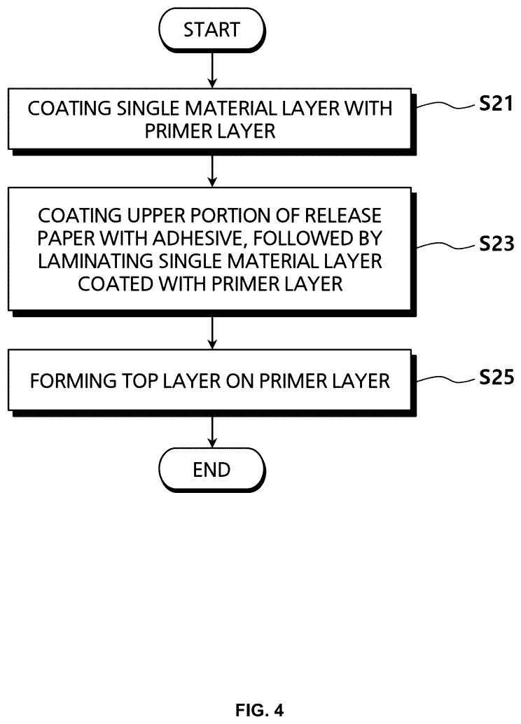

FIG. 3 is a diagram illustrating an embossed inkjet media film for large-format printing, according to a second embodiment of the present disclosure, and FIG. 4 is a flowchart illustrating a method of manufacturing the embossed inkjet media film for large-format printing, according to the second embodiment of the present disclosure.

The embossed inkjet media film 100′ for large-format printing, according to this embodiment, is similar to the embossed inkjet media film 100 for large-format printing, according to the first embodiment mentioned above, and is characterized by further including release paper 50.

In this embodiment, the descriptions of the same configurations as those in the first embodiment mentioned above will be omitted.

Referring to FIG. 3, the embossed inkjet media film 100′ for large-format printing, according to the present disclosure, includes a single material layer 10, a primer layer 20, a top layer 30, an adhesive layer 40, and the release paper 50.

The single material layer 10, the primer layer 20, and the top layer 30 are formed with the same configurations and characteristics as those in the first embodiment mentioned above.

The adhesive layer 40 is provided between the single material layer 10 and the release paper 50 and is a thermosetting adhesive made of any one of acryl, silicone, urethane, or a hot melt.

Once the upper portion of the release paper 50 is coated with the adhesive layer 40 through transfer coating, the single material layer 10 on which the primer layer 20 and the top layer 30 are formed is adhered thereto.

Such an adhesive layer 40 enables the release paper 50 to be attachable and detachable, thus allowing the embossed film 100′, according to this embodiment, to be attached to wherever desired using the adhesive component of the adhesive layer 40 by detaching the release paper 50.

The release paper 50 is attached to the adhesive layer 40 and protects the surface.

Such release paper 50 may be made of silicone or polyethylene (PE).

As illustrated in FIG. 4, for a detailed description of a method of manufacturing the embossed inkjet media film 100′ for large-format printing, according to this embodiment, the single material layer 10 is coated with the primer layer 20 (S21).

Then, the upper portion of the release paper 50 is coated with the adhesive through transfer coating to form the adhesive layer 40, followed by laminating the single material layer 10 coated with the primer layer 20 formed in Step S21 thereto (S23).

Subsequently, the top layer 30 is formed on the primer layer 20 (S25).

Such Step S25 is illustrated in FIG. 4 and is carried out in the same manner as in the first embodiment mentioned above.

### Third Embodiment

Hereinafter, another example of an embossed inkjet media film for large-format printing, according to one preferred embodiment of the present disclosure, will be described in detail with reference to the attached drawings.

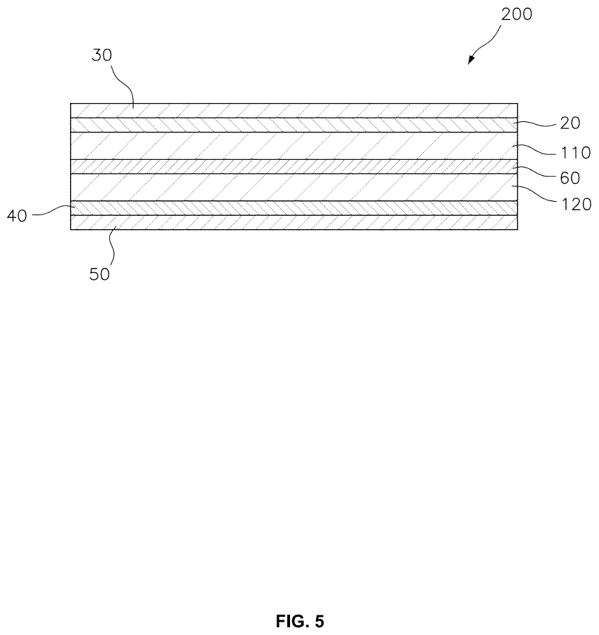

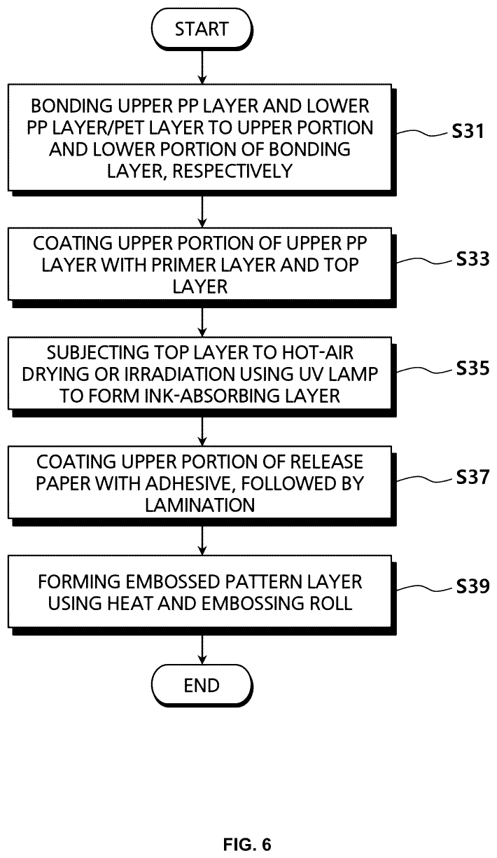

FIG. 5 is a diagram illustrating an embossed inkjet media film for large-format printing, according to a third embodiment of the present disclosure, and FIG. 6 is a flowchart illustrating a method of manufacturing the embossed inkjet media film for large-format printing, according to the third embodiment of the present disclosure.

The embossed inkjet media film 200 for large-format printing, according to this embodiment, is similar to the embossed inkjet media films 100 and 100′ for large-format printing, according to the first and second embodiments mentioned above, and is characterized by being composed of a composite material rather than a single material layer.

In this embodiment, the descriptions of the same configurations as those in the first and second embodiments mentioned above will be omitted.

Referring to FIG. 5, the embossed inkjet media film 200 for large-format printing, according to the present disclosure, includes an upper PP layer 110, a lower PP layer 120, a primer layer 20, a top layer 30, an adhesive layer 40, and release paper 50.

The primer layer 20, the top layer 30, the adhesive layer 40, and the release paper 50 are formed with the same configurations and characteristics as those in the first and second embodiments mentioned above.

The upper PP layer 110, made of PP, is attached to the upper portion of a bonding layer 60 and preferably has a thickness in the range of 60 to 300 μm.

The lower PP layer 120, made of PP, is attached to the lower portion of the bonding layer 60 and preferably has a thickness in the range of 60 to 300 μm.

The bonding layer 60 allows the upper PP layer 110 and the lower PP layer 120 to be permanently bonded, with the use of any one of a thermosetting adhesive, a thermofusible film, a thermofusible resin adhesive (for T die extrusion), or an adhesive bonding agent.

As illustrated in FIG. 6, for a detailed description of a method of manufacturing the embossed inkjet media film 200 for large-format printing, according to this embodiment, the upper PP layer 110 and the lower PP layer 120 are bonded to the upper and lower portions of the bonding layer 60, respectively, and then the resulting product is subjected to hot-air drying (S31).

Next, the upper portion of the upper PP layer 110 is coated with the primer layer 20 and the top layer 30 (S33).

Subsequently, the top layer 30 is subjected to hot-air drying or irradiation using a UV lamp to form an ink-absorbing layer (S35).

Thereafter, the upper portion of the release paper 50 is coated with an adhesive through transfer coating to form the adhesive layer 40, followed by laminating the resulting product formed through Steps S31 to S35 thereto (S37).

In the following additional process, an embossed pattern layer is formed in the top layer 30 using heat and an embossing roll (S39).

In this case, the upper PP layer 110 is made of PP, so the embossed pattern layer is formed by imprinting an embossed pattern using the embossing roll at a pressure in the range of 1 to 2 kg/cm2 under the following conditions: a temperature of a main drum in the range of 100° C. to 140° C. and a temperature of the embossing roll in the range of 30° C. to 60° C.

In the meantime, the embossed inkjet media film 200 for large-format printing, according to this embodiment, may be in a form free of the adhesive layer 40 and the release paper 50, like in the case of the first embodiment mentioned above.

In addition, once Step S39 is carried out after Steps S31 to S35 mentioned above, Step S37 to adhere the release paper 50 may be carried out.

### Fourth Embodiment

Hereinafter, another example of an embossed inkjet media film for large-format printing, according to one preferred embodiment of the present disclosure, will be described in detail with reference to the attached drawing.

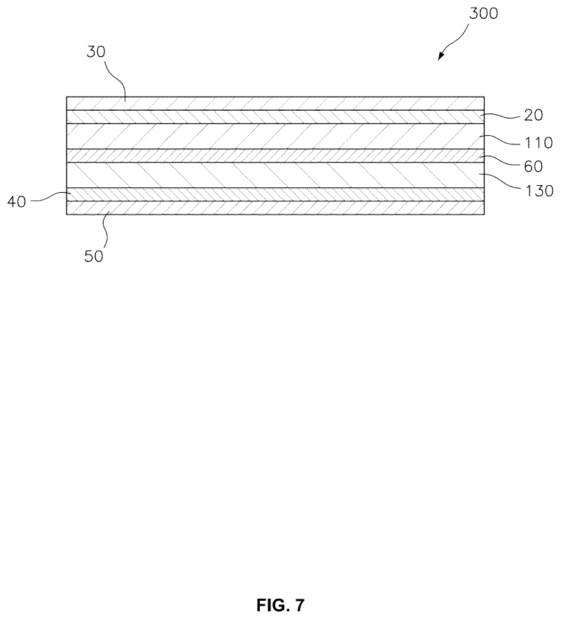

FIG. 7 is a diagram illustrating an embossed inkjet media film for large-format printing, according to a fourth embodiment of the present disclosure.

The embossed inkjet media film 300 for large-format printing, according to this embodiment, is similar to the embossed inkjet media film 200 for large-format printing, according to the third embodiment mentioned above, and is characterized by being composed of a composite material, including a PP layer and a PET layer.

In this embodiment, the descriptions of the same configurations as those in the first to third embodiments mentioned above will be omitted.

Referring to FIG. 7, the embossed inkjet media film 300 for large-format printing, according to the present disclosure, includes an upper PP layer 110, a PET layer 130, a primer layer 20, a top layer 30, an adhesive layer 40, and release paper 50.

The primer layer 20, the top layer 30, the adhesive layer 40, and the release paper 50 are formed with the same configurations and characteristics as those in the first to third embodiments mentioned above.

The PET layer 130, made of PET, is attached to the lower portion of a bonding layer 60 and preferably has a thickness in the range of 60 to 300 μm.

A method of manufacturing the embossed inkjet media film 300 for large-format printing, according to this embodiment, is carried out in the same manner as in the third embodiment described above.

The descriptions provided above are disclosed only for illustrative purposes of the technical idea of the present disclosure, and various modifications, changes, variations, and substitutions will be possible to those skilled in the art without departing from the essential characteristics of the present disclosure. In addition, as described above, the embodiments disclosed in the present disclosure and the attached drawings are not intended to limit the technical idea of the present disclosure but to explain those. Furthermore, the scope of the technical idea of the present disclosure is not limited by these embodiments and attached drawings. The protective scope of the present disclosure should be construed by the scope of the appended claims, and all technical ideas within the equivalent scope thereof should be construed as falling within the scope of rights of the present disclosure.

What is claimed is:

1. An embossed inkjet media film for large-format printing, the embossed inkjet media film comprising:
a single material layer having a thickness in a range of 60 to 300 μm;
a primer layer being formed by coating an upper portion of the single material layer with a primer solution, the primer layer being formed by coating the upper portion of the single material layer with the primer solution to a thickness in a range of 1 to 5 μm and then subjecting the resulting product to hot-air drying at a temperature in a range of 50° C. to 140° C.; and
a top layer with which an upper portion of the primer layer is coated, the top layer being embossable and printable,
wherein the top layer further comprises:
an ink-absorbing layer being formed by coating the upper portion of the primer layer with a top coating solution to a thickness in a range of 10 to 150 μm and then subjecting the resulting product to hot-air drying at a temperature in a range of 50° C. to 140° C. and irradiation using an ultraviolet (UV) lamp at a UV dose in a range of 100 to 500 mJ/cm2; and
an embossed pattern layer being formed by imprinting an embossed pattern using heat and an embossing roll.

2. The embossed inkjet media film of claim 1, wherein the single material layer is made of any one of polyvinyl chloride (PVC), polypropylene (PP), polyethylene terephthalate (PET), or paper.

3. A method of manufacturing the embossed inkjet media film of claim 1, the method comprising:
preparing a single material layer having a thickness in a range of 60 to 300 μm;
coating an upper portion of the single material layer with a primer solution to a thickness in a range of 1 to 5 μm and then subjecting the resulting product to hot-air drying at a temperature in a range of 50° C. to 140° C. to form a primer layer;
coating an upper portion of the primer layer with a top coating solution to a thickness in a range of 10 to 150 μm and then subjecting the resulting product to hot-air drying at a temperature in a range of 50° C. to 140° C. and irradiation using a UV lamp at a UV dose in a range of 100 to 500 mJ/cm2 to form an ink-absorbing layer; and
forming an embossed pattern layer using heat and an embossing roll.

4. An embossed inkjet media film for large-format printing, the embossed inkjet media film comprising:
an upper PP layer being attached to an upper portion of a bonding layer and having a thickness in a range of 60 to 300 μm;
a lower PP layer or a PET layer being attached to a lower portion of the bonding layer and having a thickness in a range of 60 to 300 μm;
a primer layer being formed by coating an upper portion of the upper PP layer with a primer solution, the primer layer being formed by coating the upper portion of the upper PP layer with the primer solution to a thickness in a range of 1 to 5 μm and then subjecting the resulting product to hot-air drying at a temperature in a range of 50° C. to 140° C.; and
a top layer with which an upper portion of the primer layer is coated, the top layer being embossable and printable,
wherein the top layer further comprises:
an ink-absorbing layer being formed by coating the upper portion of the primer layer with a top coating solution to a thickness in a range of 10 to 150 μm and then subjecting the resulting product to hot-air drying at a temperature in a range of 50° C. to 140° C. or irradiation using a UV lamp at a UV dose in a range of 100 to 500 mJ/cm2; and
an embossed pattern layer being formed by imprinting an embossed pattern using heat and an embossing roll.

5. The embossed inkjet media film of claim 4, wherein the embossed pattern layer is formed by imprinting the embossed pattern using the embossing roll at a pressure in a range of 1 to 3 kg/cm2 under the following conditions: a temperature of a main drum in a range of 140° C. to 170° C. and a temperature of the embossing roll in a range of 30° C. to 60° C.

6. A method of manufacturing the embossed inkjet media film of claim 4, the method comprising:
bonding an upper PP layer having a thickness in a range of 60 to 300 μm to an upper portion of a bonding layer and bonding a lower PP layer or a PET layer having a thickness in a range of 60 to 300 μm to a lower portion of the bonding layer;
coating an upper portion of the upper PP layer with a primer solution to a thickness in a range of 1 to 5 μm and then subjecting the resulting product to hot-air drying at a temperature in a range of 50° C. to 140° C. to form a primer layer;
coating an upper portion of the primer layer with a top coating solution to a thickness in a range of 10 to 150 μm and then subjecting the resulting product to hot-air drying at a temperature in a range of 50° C. to 140° C. or irradiation using a UV lamp at a UV dose in a range of 100 to 500 mJ/cm2 to form an ink-absorbing layer; and
forming an embossed pattern layer using heat and an embossing roll.
